(19) United States
(12) Patent Application Publication
(10) Pub. No.: US 2025/0367857 A1
(43) Pub. Date: Dec. 4, 2025

(54) METHOD FOR MANUFACTURING A TANK FOR STORING A FLUID UNDER PRESSURE AND TANK THUS OBTAINED

(71) Applicants: ARKEMA FRANCE, COLOMBES (FR); OLLOW, CANEJEAN (FR)

(72) Inventors: Gilles HOCHSTETTER, COLOMBES (FR); Thibaut SAVART, LACQ (FR); Arthur BABEAU, LACQ (FR); Axel SALINIER, LACQ (FR); Patrice GAILLARD, LACQ (FR); Bertrand LAINE, CANEJEAN (FR); Aymeric AZRAN, CANEJEAN (FR)

(21) Appl. No.: 18/872,778

(22) PCT Filed: Jun. 7, 2023
(86) PCT No.: PCT/FR2023/050810

§ 371 Date: Dec. 6, 2024

(30) Foreign Application Priority Data
Jun. 8, 2022 (FR) FR2205498

(51) Int. Cl. B29B 11/16; B29C 70/32; B29C 70/86; B29K 77/00; B29L 31/00; B60K 15/03; F17C 1/06

(52) U.S. Cl. CPC B29B 11/16; B29C 70/32; B29C 70/86; B60K 15/03; F17C 1/06; B29K 2077/10; B29L 2031/7156; B60K 2015/03315; F17C 2221/012

(57) ABSTRACT

The invention relates to a method for manufacturing a tank, said method comprising #: (i) manufacturing an elongate and unconsolidated textile preform comprising several layers of the thermoplastic composite tapes, each layer comprising at least one tape wound at a given angle, said preform being manufactured by means of a specific device, said preform being manufactured according to a method comprising: implementing feed means on each of the modules, said feed means comprising selected tapes, said selected tapes comprising at least thermoplastic composite tapes, setting the speed of advance VI and the speed of rotation V2 of each of the modules and switching each module on, cutting the elongate element and/or exhausting the supply of tapes, and recovering the unconsolidated elongate textile preform obtained: step i) comprising no step of braiding the tapes, (ii) consolidating the textile preform obtained in the preceding step by heating and cooling the thermoplastic composite tapes.

### FIELD OF THE INVENTION

The invention relates to a tank for storing a pressurized fluid, in particular hydrogen, including an elongate textile element, and to the method of manufacturing thereof.

### TECHNOLOGICAL BACKGROUND

The invention relates to a tank including a specific elongate textile element for storing gas, in particular compressed gas at high pressure, and to the manufacturing method thereof.

One of the aims sought in the field of transport, and in particular in the automotive field, is to propose vehicles that are less and less polluting. Thereby, electric or hybrid vehicles including a battery aim to gradually replace internal combustion engine vehicles, such as gasoline or diesel vehicles. However, it turns out that the battery is a relatively complex constituent of the vehicle. Depending on the location of the battery in the vehicle, it may be necessary to protect same from shocks and from the external environment, which may be at extreme temperatures and with a variable humidity. It is also necessary to prevent any risk of flames.

Furthermore, the batteries of electric or hybrid vehicles usually represent between 10 and 30% of the weight of the vehicle. Such excess weight leads to a number of drawbacks, including overconsumption of fuel or energy.

In addition, it is important that the operating temperature of the vehicle does not exceed 55° C. in order not to damage the battery cells and preserve the service life thereof. Conversely, e.g. during winter time, it may be necessary to raise the temperature of the battery in order to optimize the operation thereof.

Moreover, the electric vehicle still suffers from several problems, namely the autonomy of the battery, the use of rare earth in the batteries, the resources of which are not inexhaustible, as well as a problem of production of electricity in different countries, so as to be able to recharge the batteries.

Hydrogen is thus an alternative to the electric battery, since hydrogen can be transformed into electricity by means of a fuel cell and thereby power electric vehicles.

Nevertheless, hydrogen storage is technically difficult and expensive due to the very low molecular weight and the very low liquefaction temperature of hydrogen, especially when it comes to mobile storage. However, to be effective, storage should take place in small volumes, which requires the hydrogen to be kept under high pressure, taking into account the temperatures at which vehicles are used. This is the case, in particular, for fuel cell hybrid road vehicles for which an autonomy on the order of 600 to 700 km is sought, or less for essentially urban uses, in addition to battery based electrical power.

Hydrogen tanks generally consist of a metal or polymer shell (also called liner), which should prevent the diffusion of hydrogen outside the shell. The first shell should be as such protected by a second casing (generally made of composite materials) intended to withstand the internal pressure of the tank (e.g. 700 bars) and resistant to possible shocks or sources of heat. Moreover, the tank includes a valve system, which should also be safe.

According to the Memorandum on Hydrogen from the French Association for Hydrogen and fuel cells (AFHYPAC-Association Française pour l'hydrogène et la pile à combustible) Sheet 4.2, revision of December 2016, the storage and dispensing of hydrogen under pressure has been a standard practice for many years, with cylinders or cylinder assemblies, made of steel, pressurized to 20 or 25 MPa (types I and II) or metal reinforced by a winding of fibrous materials, on the outside. The disadvantage of such way of storage is the size—only 14 kg/m3 under 20 MPa and at ordinary temperature (21° C.) compared to 100 kg/m3 for methane—and especially the weight, which results from the use of steels with low stress levels in order to avoid the problems of embrittlement caused by hydrogen. The situation has changed radically with the advent of the technology of so-called type IV composite tanks. The basic principle of said tanks is to separate the two essential functions which are the leak-tightness and the mechanical resistance in order to manage one independently of the other. In said type of tank, a bladder made of (thermosetting or thermoplastic) resin called a leak-tight liner or sheath is associated with a reinforcing structure consisting of fibers (glass, aramid, carbon) impregnated with thermosetting resin called a reinforcing sheath or layer. Said type of tank makes it possible to work at much higher pressures while reducing the weight of the tank and preventing the risk of explosive rupture in the event of severe external aggressions. Thereby, a pressure of 70 MPa (700 bar) has become practically the current standard.

In type IV tanks, the leak-tight layer and the reinforcing layer are made of different materials, which do not adhere to each other, often responsible for the collapse of the leak-tight layer, whenever, simultaneously, there is both an accumulation of gas at the interface between the leak-tight layer and the reinforcing layer and a decrease in the internal pressure of the tank. Furthermore, the drying of type IV tanks, which takes place after the water pressure test, takes a long time and is expensive, as drying can only take place under vacuum due to the risk of collapse of the leak-tight layer.

Such problem has given rise to the development of type V tanks, which are based on the use of the same polymer for the leak-tight layer and for the matrix of the reinforcing layer, or at a minimum of a polymer compatible with the polymer composing the composite matrix (so-called type 4.5 tanks) in order to provide excellent and durable weldability between the two layers, thereby serving to obtain a single-block tank. Such types of tanks are still at the R&D stage.

To produce the composite shell, it is known how to use epoxy resins as matrix of the composite, for manufacturing tanks which can have a high glass transition temperature (hereinafter Tg), i.e. a Tg greater than 100° C. The disadvantage of the composites containing thermosetting resins, in particular epoxy resins, is that same are generally microcracked, after the curing of the thermosetting resin, even after having undergone a certain number of pressure/reduced pressure cycles, induced by filling/emptying cycles, which causes great variability or even a loss of mechanical strength. In anticipation of such a drop in performance over time, it is thus necessary to increase the carbon fiber content and hence the weight and cost of the tank.

Furthermore, in the case of thermosetting resins, in particular epoxy resins, microcracking adversely affects the impermeability of the composite reinforcement, which requires the use of a thick leak-tight layer inside the tank (i.e. a type IV tank).

Finally, in terms of recyclability, current type IV tanks use reinforcing layers made of thermosetting resins, in particular epoxy resins, which are not recyclable.

However, despite the improvements made to type IV tanks, same still have drawbacks. In particular, it is sought to accelerate the filling speed of the tank. Ain addition, the temperature resistance of gas tanks, in particular hydrogen tanks, is too low with current solutions. Accelerating the filling speed of the tank would be an advantage, in particular cost-saving for the consumer, in particular without having, in addition, to cool the hydrogen to −60° C. before filling.

The use of a polyphthalamide reinforcing layer (hereinafter referred to as PPA) with a high glass transition temperature (hereinafter Tg) would be an important advantage in terms of mechanical resistance at high temperatures. Furthermore, said type of resin being thermoplastic, same would serve to obtain an easily recyclable tank. The thermoplastic nature of the resin would reduce the level of microcracking of the composite shell, thereby reinforcing the mechanical resistance thereof and reducing the variability of the mechanical resistance, which would significantly reduce the amount of carbon fibers used and hence the cost and the carbon footprint of the type V tank compared to same of a type IV tank. Furthermore, the semi-crystalline nature of the resin would increase the leak-tightness to gases, and in particular to hydrogen. Therefore, the composite shell would contribute to the impermeability of the tank and thereby reduce the thickness of the leak-tight layer and hence the cost and the weight of the inner leak-tight layer of the tank.

However, the manufacture of such type of tank by winding hot composite tapes on a thermoplastic polymer leak-tight layer, raises difficulties, linked to the occurrence of significant residual stresses of thermal origin, inherent in the differential expansions of the materials involved, more particularly inherent in the differential expansions between the fibers and the polymer composing the leak-tight layer, during the cooling of the tank, at the end of the manufacture thereof. The above is particularly exacerbated in the case of a PPA matrix composing the carbon fiber composite reinforcement. Indeed, the high temperature for using the composite tape containing PPA, due to the high melting point of such type of resin, as well as the high Tg thereof, are the major sources responsible for the additional residual stresses in the tank. When the tank includes molded inserts of polyamide resin with low Tg, typically a Tg on the order of 50° C., said residual stresses may lead to a deformation of the inserts, preventing the complete manufacture of the tank and in particular the fastening of the bases closing the tank. When the container is a type V (or 4.5, i.e. the polymer composing the matrix of the composite is of a different nature from the polymer of the leak-tight layer, but the two polymers remain compatible and weldable to each other) tank and same has a polyamide leak-tight layer with a low Tg, more particularly an aliphatic polyamide, the residual stresses may lead to a decohesion within the composite reinforcing layer as such.

Moreover, the methods for manufacturing such composite tanks are generally slow and expensive. Thereby, conventionally based on wet filamentary winding or hot winding of thermoplastic composite tapes, the manufacture of a single-piece composite tank, of 60 liters and more, requires cycle times of several hours. Furthermore, such methods prove to be inefficient, below a certain tank size, typically below 30 liters. Finally, the quality of the composite obtained is imperfect, due to the presence of porosities, linked to the low pressure applied during the use of the fibers pre-impregnated with resin, when it comes to wet impregnation or during the in situ consolidation of thermoplastic composite tapes.

Thus, the usual methods for manufacturing such composite tanks do not make possible an easy and efficient preparation of conformable composite tanks, i.e. tanks that can be inserted into volumes of complex and/or narrow shape, in at least one of the three dimensions, such as e.g. the volume of a battery pack. One of the most promising types of conformable tank is an assembly of small diameter composite tubes (typically <200 mm in diameter) connected to each other by pipes. However, as indicated hereinabove, the current methods allow tanks to be manufactured in one piece, typically of 60 liters, thus having a large overall size and at a minimum impossible to insert into a battery pack, but said methods are not suitable for the manufacture of tubular tanks of small diameters.

Consequently, a simple, rapid and inexpensive process is sought today, making it possible to produce tanks having good mechanical strength at high temperature, recyclable and conformable, having good gas leak-tightness. Such tanks would thereby serve to store hydrogen and also any type of gas under pressure, and in particular under high pressure.

Therefore, tanks are currently sought that have a good mechanical resistance at high temperature, recyclable and conformable, have good gas leak-tightness, and are easy to manufacture. Such tanks would thereby serve to store hydrogen and also any type of gas under pressure, and in particular under high pressure.

### SUMMARY OF THE INVENTION

Such problem is solved by the method of the invention which comprises two steps:
A first step i) of manufacturing an elongate and unconsolidated textile preform, comprising a plurality of layers of at least one thermoplastic composite tape, preferably a plurality of layers of tapes, each layer comprising a tape wound at a given angle, without crimping, where said preform can be obtained from a specific device, shown in FIG. 1;
A second stage of consolidation ii) of the textile preform obtained in the preceding stage, in particular under pressure.

The method has many advantages.

First of all, unlike methods involving braiding or weaving and which require passing over the same layer in order to stack a plurality of layers of woven or braided tapes, the manufacture of the preform according to step i) of the method of the invention can be carried out continuously, and thus makes possible to obtain, rapidly and inexpensively, textile preforms of large dimensions, in particular of small diameter with great lengths.

Furthermore, step i) of the method according to the invention makes it possible to superimpose a very large number of layers: the preform may contain as many desired layers of tape as there are modules used.

The device implemented in step i) implements guides for deploying the tapes along the same direction. The device thereby makes it possible to produce elongate textile preforms of different shapes, whether or not cylindrical. The preform obtained according to step i) may also comprise restrictions of cross-section, at which certain tapes may be cut and welded, and inserts positioned, in particular before consolidation. Similarly, the preform can be easily bent at room temperature in order to give same a particular non-rectilinear shape which can then be frozen during the consolidation step ii). However, thereof will require a particular choice of fiber orientations in the different layers of the preform. Thereby, the method serves to easily obtain conformable tanks, which can in particular be inserted into a volume similar to a battery pack of a motor car.

Advantageously, step ii) makes it possible to co-consolidate, within a single step, thermoplastic or metal inserts with the tapes of the textile preform, in particular making it possible to close the tube to make a tank therefrom, which is an additional economic advantage of the method of manufacturing tanks according to the invention. Furthermore, the co-consolidation makes it possible to improve the mechanical strength and/or cohesion between the insert and the co-consolidated elongate textile element.

The invention thereby relates, according to a first aspect, to a method of manufacturing a tank, in particular for storing a fluid under pressure, comprising an elongate textile and consolidated element, said method comprising the steps of:
(i) Manufacture of an unconsolidated and elongate textile preform comprising a plurality of layers of thermoplastic composite tapes, each layer comprising at least one tape wound at a given angle, the said preform being manufactured by means of a device (1) comprising:
   a frame (2) comprising a main longitudinal guide (3) along a direction X, said guide (3) being attached to the frame (2) and
   at least two modules (4) arranged in series around the guide (3) along the direction X, each module (4) comprising:
   a feeding crown (5) surrounding a section of the guide (3),
   feeding means (6) arranged on the crown (5) apt to feed at least one tape (10) toward the guide (3) at a winding angle comprised between −90° and 90° with the direction X and at an advance feed V1, each tape (10) being apt for winding at least around the guide (3) or on the upper layer of tape (10), and means of driving (15) the crown (5) apt to rotate the crown (5) around the guide (3) at a speed of rotation V2,
      Said preform being manufactured by a method comprising the steps of:
Implementation of the feeding means (6) on each of the modules (4), said feeding means (6) comprising selected tapes (10), said selected tapes (10) comprising at least thermoplastic composite tapes
Parameterization of the speed of advance V1 and of the speed of rotation V2 of each of the modules (4) and start of each module (4),
Cutting the elongate element (11) and/or running out of tapes (10), and
Recovery of the unconsolidated elongate textile preform (11) obtained;
   step i) not comprising any step of braiding tapes,
(ii) Consolidation of the textile preform obtained in the preceding step, by heating and cooling the thermoplastic composite tapes, whereby the preform is consolidated and an elongate and consolidated textile element is obtained.

In some embodiments, the method according to the invention further includes one or a plurality of the following additional features:
the thermoplastic composite tapes comprise:
   Reinforcing fibers, either continuous or discontinuous, of an inorganic material; and
   A thermoplastic polymer composition.
the reinforcing fibers of an inorganic material are:
   impregnated at core or pre-impregnated with a thermoplastic polymer composition, or
   mixed with fibers of thermoplastic polymer(s).
the thermoplastic composite tape comprises continuous fibers impregnated with a composition containing a thermoplastic polymer, having a glass transition temperature (Tg), measured as per the standard ISO 11357-3:2013, greater than 80° C., preferably greater than or equal to 100° C., else more preferentially greater than 120° C., when the polymer is amorphous, and with a melting point greater than 150° C. when the polymer is semi-crystalline.
the thermoplastic polymer composition of the composite tape mainly comprises a polyamide, preferably semi-crystalline.
the polyamide is an aliphatic, cycloaliphatic or semi-aromatic polyamide.
The aliphatic polyamide is selected from PA 5, PA5-10, PA6, PA66, PA6-10, PA6-12, PA6-18, PA9, PA10-10, PA 10-12, PA11, PA12, and mixture thereof.
the semi-aromatic polyamide is chosen from A MPMDT/6T, PA 11/6T, PA 11/10T, PA 11/BACT, PA 5T/10T, PA 11/6T/10T, PA MXDT/4T, PA MXDT/6T, PA MXDT/10T, PA MPMDT/4T, PA MPMDT/6T, PA MPMDT/10T, PA BACT/10T, PA BACT/6T, PA BACT/4T, PA BACT/10T/6T, PA 11/BACT/4T, PA 11/BACT/6T, PA 11/BACT/10T, PA 11/MXDT/4T, PA 11/MXDT/6T, PA 11/MXDT/10T, PA 11/MPMDT/4T, PA 11/MPMDT/6T, PA 11/MPMDT/10T, PA 11/MXDT/10T, PA11/5T/10T, and mixtures thereof,
the fibers of thermoplastic composite tapes are chosen from glass fibers, carbon fibers, basalt or basalt-containing fibers.
the fibers of thermoplastic composite tapes are unidirectional, i.e. all oriented according to the length of the tape.
the composite tapes have a fiber content comprised between 40 and 70% by volume, preferably between 50 and 60% by volume of thermoplastic composite tapes.
the selected tapes (10) further comprise non-composite tapes (10) of thermoplastic polymer.
the non-composite thermoplastic polymer tapes (10) represent a minor mass fraction of the preform relative to the mass fraction of the thermoplastic composite tapes.
the polymer composition forming the non-composite thermoplastic tapes (10) comprises predominantly a polyamide, preferably a semi-crystalline polyamide.
the thermoplastic polymer composition of the thermoplastic composite tapes (10) on the one hand, and same of the tapes (10) of non-composite thermoplastic polymer on the other hand, are compatible, in particular identical.
the tapes (10) have a thickness comprised between 50 and 300 μm, in particular between 50 and 260 μm and more particularly between 60 μm and 170 μm.
the tapes (10) have a width comprised between 5 mm and 50 mm, in particular between 10 mm and 15 mm.
the winding angle of the tape (10) relative to the direction X is comprised between +90° and −90°.
the winding angle is equal to +/−54.8° to +/−10°, preferably +/−5″, better still +/−1°.
The textile preform manufactured in step i) comprises a variation of cross-section, in particular a sequential variation along the direction X.
step ii) is carried out in a mold, in particular external to the preform, more particularly a closed mold.
step ii) the pressure is applied by means of a bladder internal to the preform.
prior to step ii), an insert is positioned at the ends of the preform obtained in step i), preferably on the outside of the ends of the preform.
the insert is made of a possibly composite thermoplastic material.
in step ii), the insert is co-consolidated with the tapes (10) during consolidation step ii).

According to a second aspect, the invention relates to a tank, in particular for storing a fluid under pressure, more particularly hydrogen, comprising at least one textile and consolidated elongate element, which can be obtained according to the method of the invention.

In some embodiments, the tank according to the invention comprises one or a plurality of the following additional features:
each consolidated elongate element is provided with an insert at the ends thereof.
the insert is:
an insert closing the elongate and consolidated element, or
an insert with an orifice, intended to let the fluid in and out.
the tank comprises a plurality of consolidated elongate elements, in series, connected to each other via connectors.

The inventors were able to show that the tanks comprising an elongate and consolidated textile element obtained according to the method of the invention have very good mechanical strength compared to the composite tanks of the prior art.

Indeed, contrary to conventional methods involving a braiding of composite tapes, the method of the invention makes possible winding of the tapes without crimping, which prevents local overstress at the points of intersection of the fibers with one another, and hence improves the mechanical strength of the elongate textile element obtained after consolidation.

Advantageously, the consolidation step ii) can be carried out under pressure, in particular under a pressure comprised between 5 and 10 bars, which makes it possible both to further improve the mechanical strength and to reduce the porosity of the composite material.

Conventional methods using wet filamentary winding or winding of thermoplastic composite tapes do not allow high pressure to be applied, in particular for a prolonged period of time, so that the quality of the consolidation is often quite low.

Furthermore, the inventors observed that step ii) of consolidation of the preform under pressure serves to impart to the elongate and consolidated textile element obtained, a very low residual porosity, in particular less than 5%, more particularly less than 2%, which serves to reinforce the barrier effect played by the liner in type IV or 4.5 tanks, or even to dispense with a liner and obtain a type V tank.

Furthermore, according to another advantage, when the thermoplastic polymer composition forming the composite tapes is or comprises a semi-crystalline thermoplastic polymer, in particular polyphthalamide, the crystallization of the resin during the cooling step advantageously makes it possible to further improve the barrier effect of the tank with respect to the fluid under pressure.

Advantageously, the step of consolidation of the preform in a closed mold also makes it possible to reduce the thermoxidation of the resin which occurs during a placement of thermoplastic tape in the open air, and thereby to contribute to improving the mechanical properties of the composite tubular structure thereby obtained.

According to a third aspect, the invention relates to an unconsolidated and elongate textile preform, which can be obtained according to step i) of the method according to the invention.

According to a fourth aspect, the invention relates to a battery pack, in particular for a motor vehicle, comprising a hydrogen storage tank according to the invention.

According to a fifth aspect, the invention relates to the use of the device according to the invention, as described in particular in FIGS. 1 to 11, for preparing a tank according to the invention.

### BRIEF DESCRIPTION OF THE FIGURES

FIG. 1 shows a perspective view of an example of a device according to the invention.

FIG. 2 is a perspective view, from an angle opposite the device shown in FIG. 1.

FIG. 3 shows a perspective view of an example of an elongate element according to the invention.

FIG. 4 is a section view of FIG. 3.

FIG. 5 is a perspective view of an example of a module according to the invention.

FIG. 6 is a perspective view of the module of FIG. 5.

FIG. 7 is a perspective view of an example of tape feeding means according to the invention.

FIG. 8 is a perspective view of another example of embodiment of a device according to the invention.

FIG. 9 is a perspective view, from an angle opposite the device shown in FIG. 8.

FIG. 10 is a perspective view of an elongate element comprising a variable cross-section according to the invention.

FIG. 11 is a section view of a bent elongate element according to the invention.

It should be noted that in the figures, the structural and/or functional elements common to the different variants may have the same references.

### DETAILED DESCRIPTION

The invention is now described in greater detail and in a non-limiting manner in the following description.

Unless otherwise stated, all percentages relating to quantities are volume percentages.

### Method of Manufacturing a Tank

According to a first aspect, the invention relates to a method of manufacturing a tank, in particular for storing a fluid under pressure, comprising an elongate and consolidated textile element, said method comprising the steps of:
(i) Manufacture of an elongate and unconsolidated textile preform comprising a plurality of layers of thermoplastic composite tapes, each layer comprising at least one tape wound at a given angle, said preform being manufactured by means of a device (1) comprising-:
   a frame (2) comprising a main longitudinal guide (3) along a direction X, said guide (3) being attached to the frame (2) and
   at least two modules (4) arranged in series around the guide (3) along the direction X, each module (4) comprising:
   a feeding crown (5) surrounding a section of the guide (3).
   feeding means (6) arranged on the crown (5) apt to feed at least one tape (10) toward the guide (3) at a winding angle comprised between −90° and 90° with the direction X and at an advance feed V1, each tape (10) being apt to wind at least around the guide (3) or on the upper layer of tape (10), and
   means of driving (15) the crown (5) apt to rotate the crown (5) around the guide (3) at a speed of rotation V2, said preform being manufactured according to a method comprising the steps of:
   Implementation of the feeding means (6) on each of the modules (4), said feeding means (6) comprising selected tapes (10), said selected tapes (10) comprising thermoplastic composite tapes,
   Configuration of the speed of advance V1 and of the speed of rotation V2 of each of the modules (4) and start of each module (4),
   Cutting out the elongate element (11) and/or running out of tapes (10), and
   Recovery of the unconsolidated elongate textile preform (11) obtained;
      step i) not comprising any step of braiding tapes,
(ii) Consolidation of the textile preform obtained in the preceding step, by heating and cooling the thermoplastic composite tapes, whereby the preform is consolidated and an elongate and consolidated textile element is obtained.

### Step i)

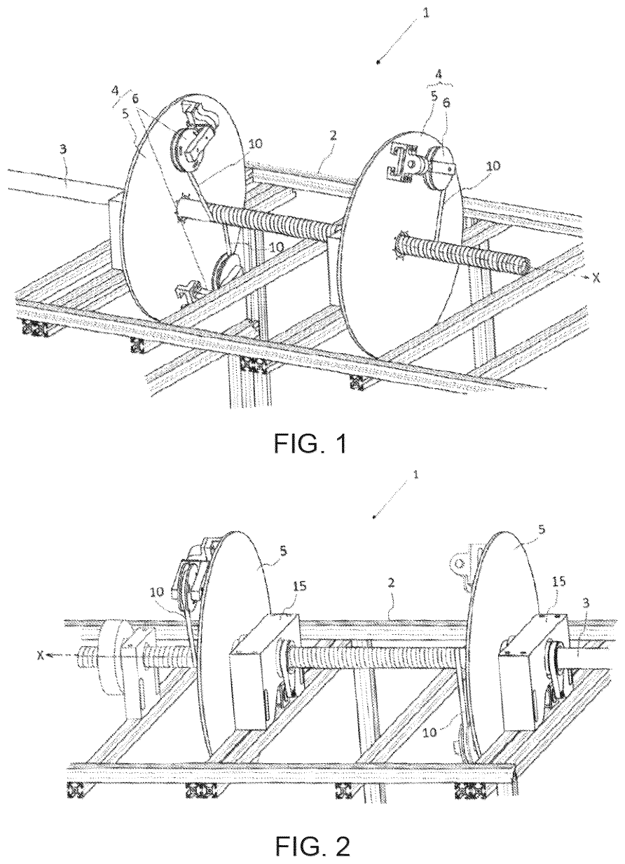

Step i) comprises the manufacture of an unconsolidated and elongate textile preform using so-called textile tapes, more particularly thermoplastic composite tapes. Step i) is carried out by means of a specific device described in FIGS. 1 to 11.

As defined by the invention, a tape is called textile and thus comprises fibers, e.g. unidirectional carbon fibers, it is then a question of dry fibers. A tape compatible with the invention is apt to be wound around the guide and comprises a structure sufficiently rigid to stay wound around the guide.

Step i) of manufacturing the preform does not include any step of braiding tapes. Same thereby serves to manufacture an elongate textile preform that is not consolidated, without crimping, i.e. having a crimping—denoted by E—of less than 0.5%, preferably equal to 0%.

“Without crimping”, as defined by the invention, means that the constituent tapes of the textile do not undulate.

The length of a fabric is always less than the length of the constituent threads or tapes, since crossing the warp thread or tapes with the weft (or of the different orientations of threads/tapes for a braid or a textile) consumes length. Said difference is the crimping and is expressed as a percentage. Crimping can be likened to the “undulation” perpendicular to the local plane of the textile of the threads or tapes within said textile.

The crimping E increases with the density of intersections between the different orientations of a fabric, a braid and more generally a textile including out-of-plane undulations of the threads or tapes thereof. Same is defined as a percentage as follows:

$$E = ( L - L 0 ) / L 0 \times 100$$

where L is the length of the textile and L0 is the length of the rectilinear thread or tape derived from the textile of length L. A crimping of less than 0.5% preferably 0% corresponds theoretically to a thread completely taut, i.e. to an absence of undulations.

### [Thermoplastic Composite Tapes]

The term “thermoplastic composite tape” refers to a tape comprising fibers of an inorganic material and a thermoplastic polymer composition apt to melt under the effect of temperature and then to solidify, and thus to consolidate the preform.

More particularly, the thermoplastic composite tapes used in step i) may comprise:
reinforcing fibers, either continuous or discontinuous, of an inorganic material; and
a thermoplastic polymer composition.

In some embodiments, the thermoplastic composite tapes comprise fibers of inorganic materials:
impregnated at core with a thermoplastic polymer composition (commonly known as a “tape”);
or pre-impregnated with a composition of thermoplastic polymers, in particular in powder form, or
mixed with fibers of thermoplastic polymer(s), and commonly known as “co-mixed tapes”.

In preferred embodiments, the thermoplastic composite tape is a tape impregnated at core with a thermoplastic polymer composition.

In some embodiments, the thermoplastic composite tape comprises continuous fibers impregnated with a composition containing a thermoplastic polymer, having a glass transition temperature (Tg), measured as per the standard ISO 11357-3:2013, greater than 80° C., preferably greater than or equal to 100° C., else more preferentially greater than 120° C., when the polymer is amorphous, and a melting point greater than 150° C. when the polymer is semicrystalline.

In some embodiments, the thermoplastic polymer composition of the composite tape comprises predominantly a polyamide, preferably a semi-crystalline polyamide.

In some embodiments, the polyamide is an aliphatic, cycloaliphatic or semi-aromatic polyamide.

The aliphatic polyamide may be chosen from PA 5, PA5-10, PA6, PA66, PA6-10. PA6-12, PA6-18, PA9, PA10-10, PA 10-12, PA11, PA12, and a mixture thereof.

The semi-aromatic polyamide may be chosen from PA MPMDT/6T, PA 11/10T, PA 11/BACT, PA 5T/10T, PA 11/6T/10T, PA MXDT/4T, PA MXDT/6T, PA MXDT/10T, PA MPMDT/4T, PA MPMDT/6T, PA MPMDT/10T, PA BACT/10T, PA BACT/6T, PA BACT/4T, PA BACT/10T/6T, PA 11/BACT/4T, PA 11/BACT/6T, PA 11/BACT/10T, PA 11/MXDT/4T, PA 11/MXDT/6T, PA 11/MXDT/10T, PA 11/MPMDT/4T, PA 11/MPMDT/6T, PA 11/MPMDT/10T, PA 11/MXDT/10T, PA11/5T/10T, and mixtures thereof,

The fibers of the composite tapes may be chosen from glass fibers, carbon fibers, basalt or basalt-containing fibers.

The fibers of thermoplastic composite tapes are preferably unidirectional, which means that in such case, the fibers are all oriented in the same direction, i.e. along the length of the tape. The tapes can also consist of a plurality of layers of fibers superimposed on each other and having different orientations from one layer to another: however, even in such case, the fibers are non-woven and/or non-braided.

In some embodiments, the composite tapes contain a fiber content comprised between 40 and 70% by volume, preferably between 50 and 60% by volume of the material forming the composite tapes. The percentage of fibers can be determined according to well-known methods such as the methods described in ISO14127:2008

In some embodiments, the selected tapes (10) further comprise non-composite tapes (10) of thermoplastic polymer.

In other embodiments, the non-composite thermoplastic polymer tapes (10) represent a minor mass fraction of the preform relative to the mass fraction of the thermoplastic composite tapes.

In yet other embodiments, the polymer composition of the non-composite thermoplastic tapes (10) comprises predominantly a polyamide, preferably a semi-crystalline polyamide.

In variants of embodiments, the tapes (10) have a thickness comprised between 50 and 300 μm, in particular between 50 and 260 μm and more particularly between 60 μm and 170 μm.

In variants of embodiments, the tapes (10) have a width comprised between 5 mm and 50 mm, in particular between 10 mm and 15 mm.

The tapes are deposited toward the guide with a winding angle strictly greater than −90° with respect to the direction X of feed of the textile element and strictly less than 90° with respect to the X direction of feed of the textile element.

In other words, the winding angle of the tape (10) with respect to the direction X is comprised between +90° and −90°, the +90° and −90° limits not being included.

In some embodiments, the winding angle is equal to +/−54.8° to +/−10°, preferably +/−5° C., better still +/−1°.

According to one embodiment of the invention, the method further comprises a step of varying the diameter, or the cross-section if it does not concern a tube with a circular section, of the elongate element. Means other than the implementation of the secondary guide may be used to enlarge or reduce the diameter, or the cross-section if it does not concern a tube with a circular section, of the elongate element.

The textile preform obtained at the end of step I) generally comprises a plurality of layers, in particular as many layers as modules (4) used. Each layer is formed by winding a tape, which may have an identical or different nature to the nature of the tape of at least one adjacent layer.

Thereby, the non-composite thermoplastic tapes may in particular be inserted between two layers of thermoplastic composite tape and/or form the inner layer of the preform and thus of the elongate textile element after consolidation. Said inner layer formed by non-composite thermoplastic tapes may in particular act as a barrier layer with regard to the fluid contained in the tank.

In some embodiments, the thermoplastic polymer composition of the thermoplastic composite tapes (10) and the thermoplastic non-composite polymer tapes (10) are compatible, more particularly are totally or partially miscible, and are in particular identical.

The total or partial compatibility of said compositions making possible the welding thereof is defined by the ratio composed of:
the difference in the glass transition temperatures of the two compositions present in the interfacial layer created by the weld,
divided by the difference in the glass transition temperatures of the two compositions, before the mixing by welding of the two compositions.

The compatibility is total when said ratio is equal to 0, and partial when said ratio is different from 0 and less than 1, in absolute value. A total incompatibility of the polyamide comprised in the composition forming the leak-tight layer with the polyamide comprised in the composition impregnating the fibrous material of the intermediate layer, is excluded. Similarly, a total incompatibility of the polyamide comprised in the composition which impregnates the fibrous material of the intermediate layer with the polyamide in the composition which impregnates the fibrous material of the outer layer, is excluded.

Advantageously, when the compatibility of said compositions is partial, said ratio is less than 30%, preferentially less than 20%, in absolute value.

In some embodiments, the glass transition temperature or temperatures of the mixture, depending on whether the compatibility is total or partial, should be comprised between the glass transition temperatures of said polyamides before mixing and different from same, by at least 5° C., preferentially by at least 10° C.

The expression “totally compatible” means that when e.g. two polyamides denoted PAa and PAb, having a Tga and a Tgb, respectively, are present in two adjacent leak-tight layers or reinforcing layers, respectively, and Tga is less than Tgb, then the mixture of the two polyamides has only one Tgab, the value of which is comprised between Tga and one Tgb.

Advantageously, when the compatibility of said compositions is partial, said ratio is less than 30%, preferentially less than 20%, in absolute value.

In some embodiments, the glass transition temperature or temperatures of the mixture, depending on whether the compatibility is total or partial, should be comprised between the glass transition temperatures of said polyamides before mixing and different from same, by at least 5° C., preferentially by at least 10° C.

The expression “totally compatible” means that when e.g. two polyamides denoted PAa and PAb, having a Tga and a Tgb, respectively, are present in two adjacent layers, and Tga is less than Tgb, then the mixture of the two polyamides has only one Tgab, the value of which is comprised between Tga and one Tgb.

The value Tgab value is then greater than Tga by at least 5° C., more particularly by at least 10° C., and less than Tgb by at least 5° C., more particularly by at least 10° C.

The expression “partially compatible” means that when e.g. two polyamides PAa and PAb, having a Tga and a Tgb, respectively, are present in two adjacent leak-tight layers or two reinforcing layers, then the mixture of the two polyamides has two Tg: Tg′a and Tg′b, with Tga<Tg′a<Tg′b<Tgb.

Said values Tg′a and Tg′b are then greater than Tga by at least 5° C., more particularly by at least 10° C., and lower than Tgb by at least 5° C., more particularly by at least 10° C.

An incompatibility of two polyamides results in the presence of two Tg, Tga and Tgb, in the mixture of the two polyamides which correspond to the Tgs, Tga and Tgb respectively of the pure polymers taken separately.

If the glass transition temperatures in the mixture of the two polyamides were identical or different at the temperatures before mixing, but if the two polyamides were reactive with each other, same would not be outside the scope of the invention.

According to other embodiments, the preform may comprise a plurality of layers of thermoplastic composite tapes, the thermoplastic polymer possibly having identical or different nature compared to the thermoplastic polymer of the adjacent layer.

The preform can comprise up to 50 layers, in particular 47 layers. Same may in particular comprise 10 layers of non-composite thermoplastic tapes and 37 layers of thermoplastic composite tapes. In some embodiments, the preform comprises 10 inner layers of non-composite thermoplastic tapes, forming a leak-tight layer after consolidation, and 10 to 50 layers of thermoplastic composite tapes, in particular 37 layers of thermoplastic composite tape, more particularly impregnated at core, forming a reinforcing layer.

In variants of embodiments, the textile preform manufactured in step i) comprises a variation of cross-section, in particular a narrowing of cross-section, more particularly sequential along the direction X.

In some embodiments, the elongate element can be cut out at the narrowings of cross-section, and an insert can be positioned, if appropriate, therein.

According to one feature of the invention, each module of the device for manufacturing the preform comprises independent feeding means. Thereby, each module can dispense tapes of a different nature. The nature and dimensions of the tapes can be different from one layer to another.

According to another feature of the invention, the main longitudinal guide comprises a substantially circular or polygonal cross-section or else of free shape. The elongate element obtained may thereby have the shape of a tube or may have a more complex shape depending on the use.

According to yet another characteristic of the invention, the feeding means comprise at least one tape dispenser arranged around the feeding crown. The implementation of the tape dispenser makes possible an easy storage and dispensing of the tapes to the main guide, the dispensers rotating around the guide according to the speed of rotation of the feeding crown.

According to one embodiment of the invention, the tape dispensers comprise pivoting means on the feeding crown. The use of pivoting means serves to orient the dispensing of the tapes toward the guide and thereby to choose an angle between −90° and 90° between the tape and the guide. All the tapes of the same module have substantially the same angle with the guide.

According to another embodiment of the invention, the tape dispensers comprise at least one guillotine apt to cut at least one tape leaving a dispenser and a motorized element apt to bring the tape toward the guide.

According to another embodiment of the invention, tape dispensers comprise welding means, e.g. ultrasonic welding means, apt to weld a tape to an existing layer or upper layer. Other welding means compatible with the nature of the tapes used are possible within the framework of the invention. When the diameter, or the cross-section if it does not concern a tube with a circular cross-section, of the elongate element varies, it is advantageous to add or remove one or a plurality of tapes, which is possible in the context of the invention due to the use of the guillotine and/or of welding means.

According to one embodiment of the invention, the device further comprises a drawing aiding device apt to guide the tapes of the module or of the modules.

The use of a drawing aid facilitates the sliding of the different layers of tape along the main guide. An example of embodiment of a drawing aiding device may be a system of at least one roller arranged downstream of the last module along the direction X. Said roller or said rollers exert sufficient pressure to make the layers of tape slide over the main guide.

Depending on the nature of the tapes, the aiding device can be removed during the manufacture of the textile element which, by the rigidity thereof, can advance alone over the guide. According to other embodiments, the nature of the tapes does not require any drawing aid.

According to a variant of embodiment of the invention, the device further comprises a secondary longitudinal guide of diameter or cross-section greater than the diameter or the cross-section, if it does not concern a tube of circular cross-section, of the main guide and apt to translate over the main guide. When the device is in operation, the use of a secondary guide of greater diameter or cross-section increases the diameter, or the cross-section if it does not concern a tube, of the elongate element, the tapes being placed on the secondary guide.

The speed of advance V1 corresponds to the speed of advance of the textile element on the main guide. The speed of advance V1 is thus substantially the same for each of the modules. The speed of advance V1 and the speed of rotation V2 of each module are linked, on the one hand, to the angle defined between the tape or tapes fed by each of the modules and the feeding speed.

According to one embodiment of the invention, the method further comprises a step of storing the elongate element wound around a storage reel. The method according to the invention makes it possible to manufacture, until the tape feeding means run out, an elongate element of considerable size which can e.g. go up to a kilometer. Storing the elongate element in a reel at the outlet of the device, facilitates handling.

According to a variant of embodiment of the invention, the method further comprises the step of drawing aid for the tapes with the implementation of the drawing aiding device. The drawing aid is placed downstream of the last module delivering the last layer of the textile element. An operator can e.g. guide each layer of tape to the drawing aid, which will then help slide the different layers onto the main guide.

According to one embodiment of the invention, the storage reel is a drawing aiding device for the tapes from the feeding means of the modules of the manufacturing device.

According to one embodiment of the invention, the method further comprises the additional step of arranging a secondary longitudinal guide at the first module and translating said secondary guide along the direction X. The secondary guide makes it possible to enlarge the diameter or the cross-section if it does not concern a tube, of the elongate element being manufactured or to reduce the diameter or the cross-section of the element if a first secondary guide has already been used.

According to one embodiment of the invention, the method further comprises a step of bending the elongate element obtained at ambient temperature at a desired angle. An advantage of the manufacturing device is the possibility of bending the elongate element at room temperature.

“Ambient temperature”, as defined by the present description, means a temperature comprised between 15 and 25° C.

### Step ii)

The elongate textile preform obtained in step i) is then consolidated by heating and cooling the thermoplastic composite tapes.

More particularly, same is consolidated by melting and cooling thermoplastic composite tapes.

The heating and cooling step serves to weld together the different layers of tapes forming the preform. The heating temperature is thus determined depending upon the nature of the tapes (10) selected.

The step ii) is generally carried out at a pressure comprised between 1 bar and 25 bar, in particular between 5 bar and 10 bar, more particularly between 6 bar and 8 bar.

Step ii) may be carried out in a mold, in particular external to the preform, more particularly a closed mold.

According to embodiments of step ii), the pressure is applied by means of a bladder internal to the preform.

According to yet another embodiment of step ii), an insert is positioned at the ends of the preform obtained in step i), preferably outside the ends of the preform. In other words, the inner surface of the insert may be in contact with the outer surface of the preform.

The insert may in particular be metallic or made of a thermoplastic material, if appropriate composite.

Thereby, during step ii), the insert may advantageously be co-consolidated with the tapes of the preform during the consolidation step ii). When pressure is applied by means of a bladder internal to the preform, the tapes of the preform are pressed against the internal wall of the insert, which makes it possible in particular to obtain good consolidation of the preform and also to improve the weld, and hence the mechanical resistance, between the preform and the insert.

In such embodiments, when the winding angle of the tapes around the axis of the tube or hollow body is greater than 65°, it is preferable to cut the tapes periodically to facilitate the consolidation thereof.

### The Tank

According to another aspect, the invention relates to a tank, in particular for storing a fluid under pressure, more particularly hydrogen, comprising at least one textile and consolidated elongate element, which can be obtained according to the method as defined above.

Each consolidated elongate element is generally provided with an insert at the ends thereof. Same may comprise in particular
at least one insert provided with an orifice, intended to let a fluid in and out, and, if appropriate an insert closing the elongate element and consolidated at one of the ends thereof.

The consolidated elongate element may comprise, at each of the ends thereof, an insert provided with an orifice intended to let the fluid in and out. In such case, same is usually connected to other elongate elements via connectors.

In some embodiments, the tank comprises a plurality of elongate elements connected in series with each other by connectors.

More particularly, the first consolidated elongate element of the series may be provided with an insert including an orifice letting the fluid in and the last consolidated elongate element may be provided with an insert closing same, the intermediate consolidated elongate elements being equipped, at each of the ends thereof, with inserts provided with an orifice allowing the fluid to circulate between the first and the last elongate element of the series.

Advantageously, the tank is conformable and can be inserted into very small volumes, such as a battery pack, in particular for a motor vehicle.

### The Preform

According to yet another aspect, the invention relates to an unconsolidated and elongate textile preform, which can be obtained according to the step i) of the method as defined hereinabove.

### The Battery Pack

According to yet another aspect, the invention relates to a battery pack, in particular for a motor vehicle, comprising a tank for storing a fluid, more particularly hydrogen, as defined hereinabove.

### DETAILED DESCRIPTION OF FIGURES

A device according to the invention as illustrated in FIGS. 1 and 2 and referred to as a whole by the reference 1 is intended for the manufacture of an unconsolidated and elongate textile element. To this end, the device 1 comprises a frame 2 comprising a main longitudinal guide 3 along a direction X, and at least two modules 4 arranged in series around the guide 3 along the direction X.

The main longitudinal guide 3 is stationary on the frame 2. According to the embodiments illustrated, the main longitudinal guide 3 comprises a circular cross-section and thus has a tubular shape. Such form is not limiting for the invention, other forms of guide 3 are compatible with the invention. The guide 3 is rectilinear and may comprise cross-sections of different shapes such as square, rectangular, quadrilateral, triangular, polygonal, round, oval, or of mixed and/or free shape.

A module 4 of a device 1 according to the invention comprises, on one side, a feeding crown 5 surrounding a section of the main longitudinal guide 3. According to the examples illustrated, the feeding crown 5 has substantially the form of a disk comprising a central hole in which the guide 3 is located.

A module 4 comprises, on the other side, feeding means 6 arranged on the crown 5. According to the embodiment illustrated, the feeding means 6 are situated on one face of the disk and feed at least one tape 10 toward the guide 3 with an angle comprised between −90° and 90° with respect to the direction X.

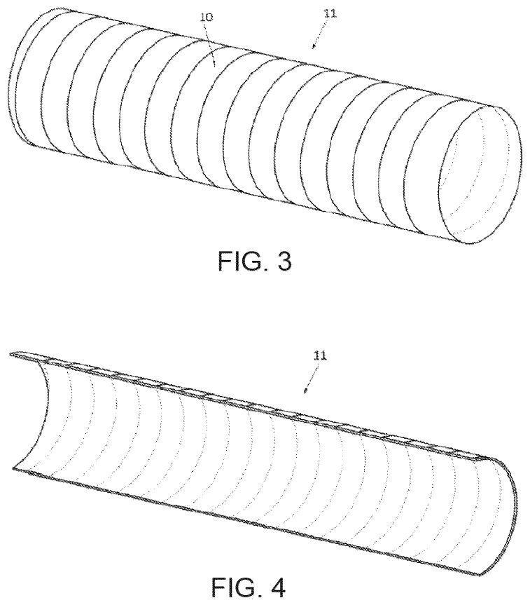

A tape 10 compatible with the invention is, on the one hand, sufficiently flexible to be wound around the guide 3. FIG. 3 illustrates an elongate element 11 obtained by means of the device 1 according to the invention. The successive layers of tape 10 arranged at different angles allow the elongate element 11 obtained to keep the shape thereof. FIG. 4 illustrates a section through the elongate element 11 where the successive layers are visible.

The feeding means 6 arranged on the crown 5 feed at least one tape 10 toward the guide 3 with a chosen angle comprised between −90° and 90° with respect to the direction X. Each tape 10 is wound at least around the guide 3 or on the already present layer of tape 10, i.e. the upper layer with a chosen overall speed of advance V1.

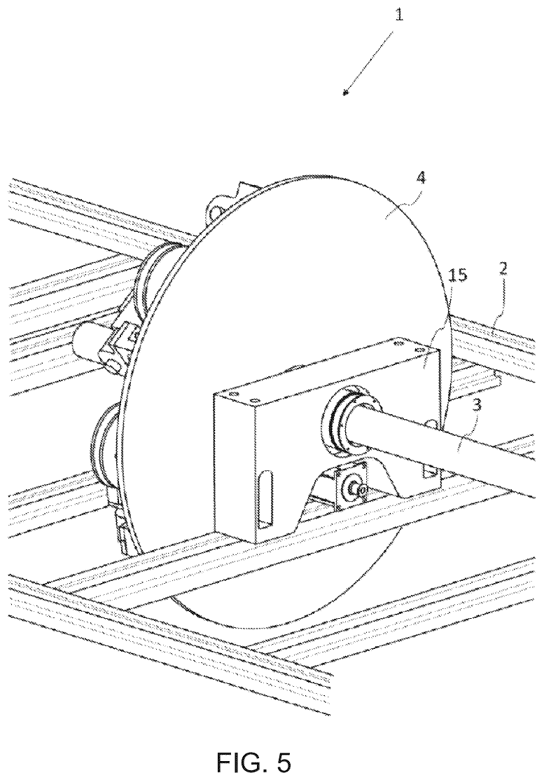

Each module 4 also further comprises means of driving 15 the crown 5. According to FIG. 2 and also visible in FIG. 5, the means of driving 15 are located on the face of the crown 5 opposite the feeding means 6. The means of driving 15 the crown 5 serve to rotate the crown 5 about the guide 3 at a speed of rotation V2. According to the embodiment illustrated, the means of driving 15 comprise a motor comprising in particular a belt apt to rotate the crown 5 and a control unit of the motor, in order implement a speed of rotation V2 of the crown 5. Such configuration is not limiting for the invention.

The device illustrated in FIGS. 1 and 2 comprises two modules 4. The feeding means 6 of the first module 4 comprise two dispensers 20 of tape 10 and the feeding means 6 of the second module 4 comprise only one dispenser 20 of tape 10. The feeding means 6 of the different modules 4 are indeed independent of one another. Thereby, each module 4 can deliver tapes 10 of different nature and a selected number of tapes 10 per layer.

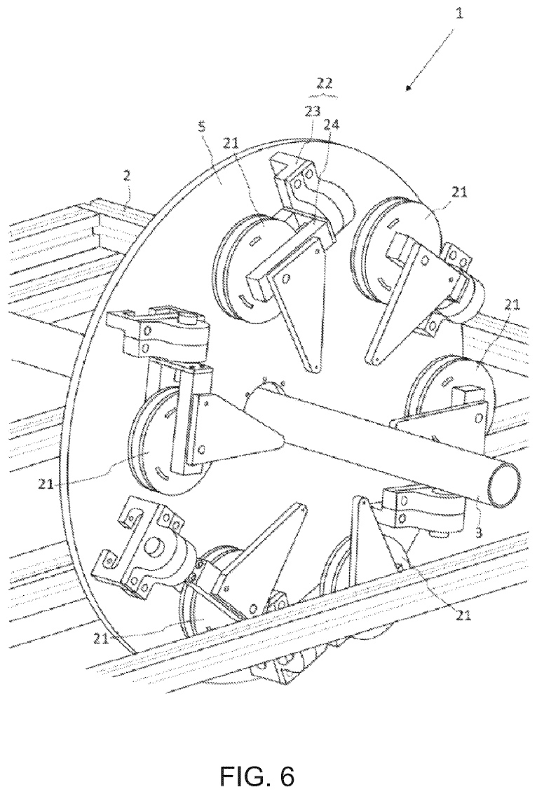

FIG. 6 illustrates a module 4 comprising six dispensers 20 of tape 10. The dispensers 20 of tape 10 are arranged around the feeding crown 5. According to the embodiments illustrated, a dispenser 20 for the tape 10 comprises a reel 21 fastened by pivoting means 22 to one face of the crown 5.

According to the illustrated embodiment, but not limited to, the pivoting means 22 comprise a fixed part 23 and a pivoting part 24 directed toward the reel 21. The reel 21 is free to pivot in the pivoting part 24 and the pivoting part is free to pivot with respect to the fixed part 23. Thereby, the reel 21 can be arranged in a desired configuration and the pivoting means 22 can be blocked in the desired arrangement of the dispenser 20.

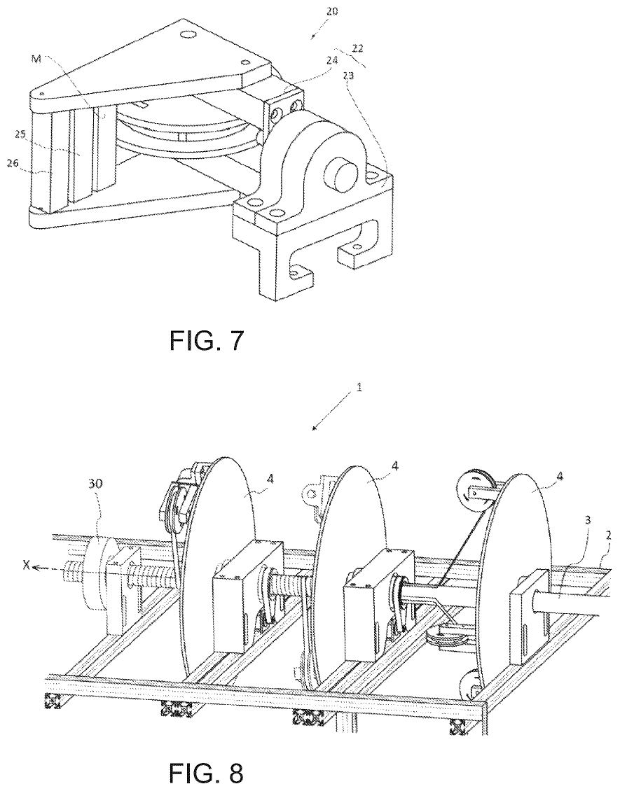

FIG. 7 illustrates a particular embodiment of the invention wherein a dispenser 20 of tape 10 further comprises a guillotine 25 apt to cut the tape 10 at the outlet of the dispenser 20, a motor M apt to feed the tape after cutting and ultrasonic means of welding 26 apt to weld a tape 10 to an existing layer of tape 10 or upper layer. The illustration of the motor M, of the guillotine 25 and of the welding means 26 is schematic in FIG. 7 and other embodiments are possible and in particular with means of acting on a tape 10 outside the dispenser 20.

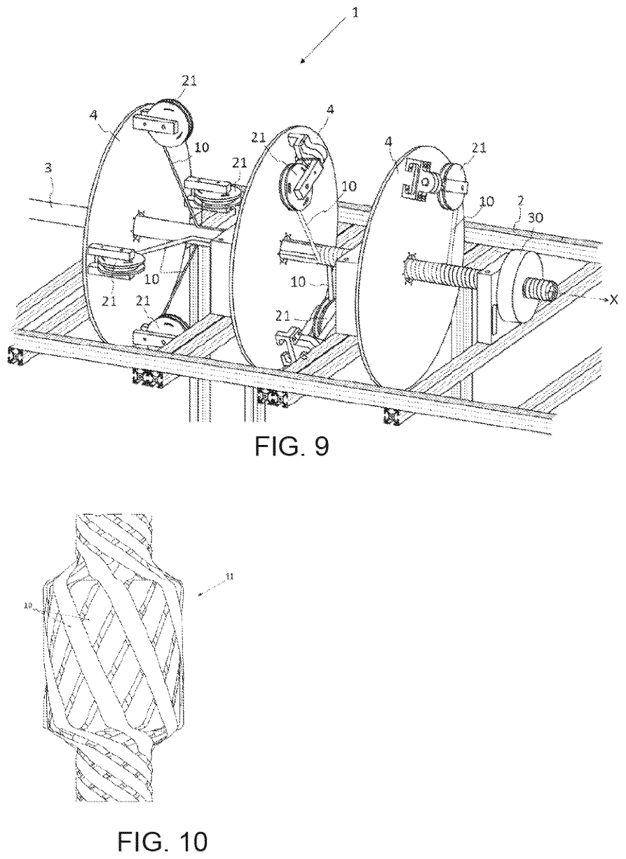

FIGS. 8 and 9 illustrate a particular embodiment of the invention. The device 1 comprises three modules 4. The first module 4 comprises four dispensers 20 of tape 10 which each place a tape 10 along the direction of advance X, i.e. the angle between the tape 10 and the guide 3 has a value of 0 degrees. The second module 4 comprises two dispensers 20 of tape 10 and finally the third module 4 comprises only one dispenser 20 of tape 10. Such embodiment is not limiting for the invention.

In order to manufacture an elongate element 11 according to the invention, a first step consists in implementing feeding means 6 on each of the modules 4 of the device 1. To this end, according to the examples illustrated, the reels 21 each comprising a chosen tape 10 are arranged on each feeding crown 5 of the device 1.

Preferably, the reels deliver the same tape 10 per module and each module 4 may comprise tape reels 10 of different type.

According to the example illustrated in FIGS. 8 and 9, the tapes 10 used have a width comprised between 20 and 10 mm and a thickness of about 150 microns.

A second step of the method consists in parameterizing, on the one hand, the speed of advance V1 and, on the other hand, the speed of rotation V2 of each of the modules 4. The precise and coordinated configuration of the two values makes it possible to define for each feeding means 6 a desired angle between the tape 10 and the guide, the angle varying between-90 and 90° excluding the two interval limits. For example, and according to the example of the device illustrated in FIGS. 8 and 9, a first layer of tape 10 is placed at an angle close to 0° with respect to the direction X, a second layer of tape 10 is placed at an angle of about 80° with respect to the direction X and a third layer is placed at an angle close to −80° with respect to the direction X.

An example of configuration consists in defining a speed of advance V1 substantially equal to one meter per minute and a speed of rotation V2 of two modules 4 each dispensing a tape 10 substantially equal to 360 revolutions per minute. The example is not limiting for the invention.

The modules 4 are then started.

Depending on the nature of the tapes 10, a drawing aiding device 30 is implemented in order to assist in drawing the tapes 10 from the different layers of the element 11. According to the embodiment illustrated in FIGS. 8 and 9, the first layer of tape 10 coming from the first module 4 slides over the main guide 3 through the other two modules 4 used. The tapes 10 of the first layer can slide alone if the nature thereof makes it possible, or with manual aid. The tapes 10 of the other layers are placed on the preceding layer and then pass through the drawing aiding device 30. The aiding device 30 is not always necessary for the implementation of the method but can assist the sliding of the different layers toward the direction X depending on the nature of the tapes 10 used.

According to a particular embodiment with, in particular, tapes of the first layer arranged at an angle close to 0° with the direction X, there is not necessarily a need for manual assistance to advance said tapes 10.

According to another embodiment, once other layers of tapes 10 are superimposed on the first layer, the elongate element 11 is manufactured without assistance and the drawing aiding device 30 is no longer useful and can be removed. Thereof may be a transitional period of start aid which is necessary if the nature of the tape 10 used does not allow the tape to deploy effectively out of the reel 21 thereof.

The elongate element 11 which is manufactured can be stored wound around a storage reel, thereby facilitating the subsequent handling thereof. The elongate element 11 can also be cut as it is manufactured according to the desired size and according to the additional steps described hereinbelow, e.g. by increasing or reducing the dimensions.

According to one embodiment (not illustrated), the storage reel is a drawing aiding device for the tapes 10. Indeed, during the winding thereof, the textile element 11 leads to the drawing of the tapes 10 forming same.

When the elongate element 11 is of the desired size, same can then be cut. Another way of finishing the method consists in waiting for the tapes 10 to run out.

The textile and unconsolidated elongate element 11 obtained can finally be recovered. Consolidation steps can then be applied thereto, e.g. a thermoforming step when the dimensions make same possible. During the consolidation of the elongate element 11, it is also possible to vary slightly the dimensions of the elongate element 11, in particular the perimeter thereof, on the order of 10-20%.

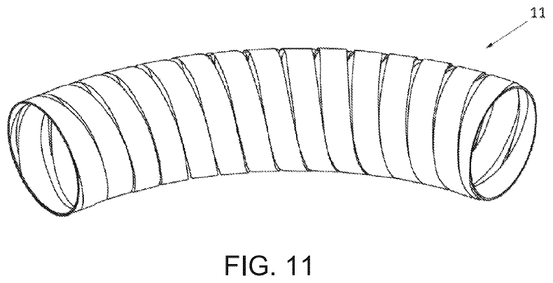

According to a particular embodiment, a secondary longitudinal guide (not shown) is arranged at the first module 4 during manufacture. The secondary guide of diameter or cross-section greater than the diameter or cross-section of the main guide 3 is placed upstream of the first module 4 and translates toward the direction of manufacturing of the elongate element 11. The tapes 10 of the different modules 4 are then placed on the secondary guide, and again on the main guide 3 after the passage of the secondary guide. It is thereby also possible to greatly increase the diameter or the cross-section or the overall shape of the elongate element 11 during the manufacture thereof. Such an elongate element 11 is illustrated in FIG. 10.

With an increase in diameter or section, tapes 10 similar to the tapes 10 fed by the corresponding module 4 can be added by means of ultrasonic welding means 26 thereby making it possible to fill in openings which might form due to the increase in the surface of the elongate element 11, such an example being illustrated in FIG. 10 with tapes 10 added to the layer below the upper layer when the diameter of the element 11 is increased and tapes 10 cut when the diameter of the element 11 is decreased.

According to another embodiment of the invention, the elongate element 11 obtained by means of the device 1 is bent at ambient temperature according to a desired angle such as the elongate element 11 which appears in FIG. 11. The step of bending at ambient temperature can be done by hand if the bending rigidity of the elongate element 11 obtained makes same possible.

According to another embodiment, not illustrated, the elongate element 11 can also be consolidated by integrating a solid matrix at one of the layers of tape 10 composing same.

Of course, various other modifications may be made to the invention within the framework of the appended claims.

### EXAMPLES

### Example 1 (According to the Invention)

The resin composing the matrix of the thermoplastic composite tape is 11/BACT/10T, the fiber used is Hyosung 2550 G10 carbon fiber, the content of fiber is 53% by volume.

The tensile stress at break at 0° (fiber direction) of the composite obtained with the composite tape is 2700 MPa. The width of the tape is 17″ and the thickness thereof is 137 μm, on average.

Positioning in the preform, of the thermoplastic composite tapes at +/−55° from the axis of the tubular tank. The preform has a cross-section restriction corresponding to half the initial diameter, allowing a metal insert to be positioned outside the preform at the 2 ends thereof.

Same includes 37 layers of thermoplastic composite tape.

The preform was manufactured continuously at a speed of 1 m/min.

Same is consolidated under a pressure of 6 bars at 300° C. The time of the temperature rise, of the hold at 300° C. and of the cooling, is of 20 minutes.

The tank is of type V. i.e. it does not have an additional leak-tight layer, the composite reinforcement ensuring such function in addition to withstanding the pressure.

The total length of the tubular tank is 123 m, the inner diameter is 110 mm in the central part, of 55 mm in the restriction and the transition between the central part and the restriction is conical at an angle of 45°. The thickness of the composite reinforcement is 5 mm. The stacking by construction does not include any braiding, the crimping E is less than 0.5%. The burst pressure of the tank is 1605 bar.

The tubular tank obtained has a capacity of 10 liters and includes 2.98 kg of composite.

### Example 2 (According to the Invention)

The resin composing the matrix of the thermoplastic composite tape is 11/BACT/10T, the fiber used is Hyosung 2550 G10 carbon fiber, the content of fiber is 53% by volume.

The tensile stress at break at 0° (fiber direction) of the composite obtained with the composite tape is 2700 MPa. The width of the tape is 17″ and the thickness thereof is 137 μm, on average.

Positioning in the preform of the thermoplastic composite tapes at +/−55° from the axis of the tubular tank. The preform has a cross-section restriction corresponding to half the initial diameter, allowing a metal insert to be positioned inside the preform.

Same includes 10 layers of thermoplastic tape with a width of 17″ and a thickness of 200 μm made of polyamide 11 and 37 layers of thermoplastic composite tape, having a width of 17″ and a thickness of 137 μm, on average.

The preform was manufactured continuously at a speed of 1 m/min.

Same is consolidated under a pressure of 6 bars at 300° C. The time of the temperature rise, of the hold at 300° C. and of the cooling, is of 20 minutes.

The resin composing the matrix of the thermoplastic composite tape is 11/BACT/10T, the fiber used is Hyosung 2550 carbon fiber, the content of fiber is 55% by vol. The width of the tape is 17″. The stacking by construction does not include any braiding, the crimping E is less than 0.5%.

The length of the tubular tank is 1.33 m, the inner diameter is 110 mm in the central part of the composite reinforcement, of 55 mm in the restriction and the transition between the central part and the restriction is conical at an angle of 45°. The thickness of the composite reinforcement is 5 mm and the thickness of the polyamide 11 leak-tight layer, resulting from the consolidation of the thermoplastic tapes included in the preform, is 2 mm. The internal diameter of the tank in the central part thereof is thus 106 mm and 51 mm in the restriction.

The 2 layers are perfectly welded together and the tank is one-piece. This type of tank is of type 4.5 (the leak-tight layer is of a different chemical nature from the layer of the matrix of the composite but the two resins are partially miscible, which makes possible a perfect weld therebetween).

The burst pressure of the tank is 1620 bars.

The tubular tank obtained has a capacity of 10.15 liters and includes 3.22 kg of composite and 0.89 kg of polyamide 11 liner

### Example 3 (According to the Invention)

Connection by means of metal fittings with a diameter of 25 mm, including a threaded connection, of 6 tubular tanks as described in example 2, to form a conformable H2 tank for a motor car, with a capacity of 61 liters (approximately). The tank, consisting of the 6 tubular tanks, withstands the same pressure of 1620 bars as each of the 6 tubular tanks taken separately. The consolidation of the 6 preforms was carried out in parallel in 6 different closed molds, under a pressure of 6 bars at 300° C. The time of the temperature rise, of the hold at 300° C. and of the cooling, was 20 minutes.

The total weight of composite used is 19.3 kg.

The total manufacturing time of the complete conformable tank is 39 minutes, broken down as follows:
Preform manufacturing time of 6×1.21=7.26 minutes+cutting time, i.e. a total of 8 minutes for placing preforms ready to be consolidated.
3 minutes to position the 6 preforms in the molds with the inserts.
20 minutes of molding time for the consolidation of the 6 preforms.
3 minutes of mold release time for the 6 preforms
5 minutes of assembly time to connect the 6 tubular tanks to each other.

### Example 4 (Comparative)

Construction of a tank with an internal volume of 61 liters for motor cars, an external diameter of 400 mm and a length of 0.88 m, (including bases) with a burst pressure of 1610 bars.

The tank is type IV and has a composite reinforcement on the outside, weighing 36.7 kg and a polyethylene leak-tight layer, weighing 5 kg on the inside. There is no adhesion between the leak-tight layer and the composite reinforcement.

The composite reinforcement is composed of an epoxy matrix and Toray carbon fiber, ref T700 S, the content of fibers is 70% by weight or 59% by volume (density of the carbon fiber used is 1.8 and the density of the epoxy resin is 1.1). Same is manufactured by wet filamentary winding: the dry fibers are unwound from a creel and are impregnated with resin by passing at a speed of 0.8 m/s, in a bath containing the liquid precursor of the epoxy resin, at room temperature. 4 strands are simultaneously wound around the liner. Each carbon strand includes 1200 filaments (carbon strand 12K), and has a linear density of 0.83 g/m. Given the content of fiber of 70% by weight, each impregnated strand has a linear density of 1.18 g/m. Thereby, the entire winding at 0.8 m/s, with 4 strands in parallel, lasts about 2.7 h. Such step is followed by polymerization of the resin in an oven at 60° C. for 8 h.

It is thus found that the manufacturing time of the type IV tank is much longer than same of the conformable type V tank of example 3 according to the invention and consumes much more composite and will thus be considerably heavier and more expensive since the price of carbon fibers is a major factor in the cost of the tank. Thereof shows that the effectiveness of the composite reinforcement in the type IV tank is at least 2 times lower than the effectiveness of the composite composing the type V tank of example 3: indeed, to contain the same volume of hydrogen gas (61 l) while resisting the same internal pressure of 1600 bars, it takes about 2 times more composite in the type IV tank made of epoxy carbon composite than in the conformable tank made of PPA carbon composite.

1. A method of manufacturing a tank, in particular for storing a fluid under pressure, comprising a consolidated and elongate textile element, said method comprising the steps of:
(i) Manufacture of an unconsolidated and elongate textile preform comprising a plurality of layers of thermoplastic composite tapes, each layer comprising at least one tape wound at a given angle, the said preform being manufactured by means of a device (1) comprising:
a frame (2) comprising a main longitudinal guide (3) along a direction X, said guide (3) being attached to the frame (2) and
at least two modules (4) arranged in series around the guide (3) along the direction X, each module (4) comprising:
a feeding crown (5) surrounding a section of the guide (3),
feeding means (6) arranged on the crown (5) apt to feed at least one tape (10) toward the guide (3) at a winding angle comprised between −90° and 90° with the direction X and at an advance feed V1, each tape (10) being apt to wind at least around the guide (3) or on the upper layer of tape (10), and
means of driving (15) the crown (5) apt to rotate the crown (5) about the guide (3) at a speed of rotation V2,
Said preform being manufactured by a method comprising the steps of:
Implementation of the feeding means (6) on each of the modules (4), said feeding means (6) comprising selected tapes (10), said selected tapes (10) comprising at least thermoplastic composite tapes
Configuration of the feed speed V1 and of the speed of rotation V2 of each of the modules (4) and start of each module (4),
Cutting the elongate element (11) and/or running out of tapes (10), and
Recovery of the resulting unconsolidated elongate textile preform;
step i) not comprising any step of braiding tapes,
(ii) Consolidation of the textile preform obtained in the preceding step, by heating and cooling the thermoplastic composite tapes, whereby the preform is consolidated and an elongate and consolidated textile element is obtained.

2. The method according to claim 1, wherein the thermoplastic composite tapes comprise:
Reinforcing fibers, either continuous or discontinuous, of an inorganic material; and
A thermoplastic polymer composition.

3. The method according to claim 2, wherein the reinforcement fibers of an inorganic material are:
impregnated at core or pre-impregnated with a thermoplastic polymer composition, or
mixed with fibers of thermoplastic polymer(s).

4. The method according to any of the preceding claims, the thermoplastic composite tape comprising continuous fibers impregnated with a composition containing a thermoplastic polymer, having a glass transition temperature (Tg), measured as per the standard ISO 11357-3:2013, greater than 80° C., preferably greater than or equal to 100° C., else more preferentially greater than 120° C., when the polymer is amorphous, and a melting point greater than 150° C. when the polymer is semicrystalline.

5. The method according to any of claims 2 to 4, wherein the thermoplastic polymer composition of the composite tape comprises predominantly a polyamide, preferably a semi-crystalline polyamide.

6. The method according to claim 5 wherein the polyamide is an aliphatic, cycloaliphatic or semi-aromatic polyamide.

7. The method according to claim 6 wherein the aliphatic polyamide is selected from PA 5, PA5-10, PA6, PA66, PA6-10, PA6-12, PA6-18, PA9, PA10-10, PA 10-12, PA11, PA12, and mixtures thereof.

8. The method according to claim 7, wherein the semi-aromatic polyamide is chosen from PA MPMDT/6T, PA 11/6T, PA 11/10T, PA 11/BACT, PA 5T/10T, PA 11/6T/10T, PA MXDT/4T, PA MXDT/6T, PA MXDT/10T, PA MPMDT/4T, PA MPMDT/6T, PA MPMDT/10T, PA BACT/10T, PA BACT/6T, PA BACT/4T, PA BACT/10T/6T, PA 11/BACT/4T, PA 11/BACT/6T, PA 11/BACT/10T, PA 11/MXDT/4T, PA 11/MXDT/6T, PA 11/MXDT/10T, PA 11/MPMDT/4T, PA 11/MPMDT/6T, PA 11/MPMDT/10T, PA 11/MXDT/10T, PA11/5T/10T and mixtures thereof.

9. The method according to any one of the preceding claims, wherein the fibers of the thermoplastic composite tapes are chosen from glass fibers, carbon fibers, basalt or basalt-containing fibers.

10. The method according to any of the preceding claims, wherein the fibers of the thermoplastic composite tapes are unidirectional, i.e. all oriented along the length of the tape.

11. The method according to any of the preceding claims, wherein the composite tapes contain a fiber content comprised between 40 and 70% by volume, preferably between 50 and 60% by volume of the thermoplastic composite tapes.

12. The method according to any of the preceding claims, wherein the selected tapes (10) further comprise non-composite tapes (10) of thermoplastic polymer.

13. The method according to claim 12, wherein the non-composite thermoplastic polymer tapes (10) represent a minor mass fraction of the preform relative to the mass fraction of the thermoplastic composite tapes.

14. The method according to claim 13, wherein the polymer composition forming the non-composite thermoplastic tapes (10) predominantly comprises a polyamide, preferably a semi-crystalline polyamide.

15. The method according to claim 14, wherein the thermoplastic polymer composition of the thermoplastic composite tapes (10) on the one hand and the composition of the non-composite thermoplastic polymer tapes (10) on the other hand are compatible, in particular identical.

16. The method according to any of the preceding claims, wherein the tapes (10) have a width comprised between 50 and 300 μm, in particular between 50 and 260 μm and more particularly between 60 μm and 170 μm.

17. The method according to any of the preceding claims, wherein the tapes (10) have a width comprised between 5 mm and 50 mm, in particular between 10 mm and 15 mm.

18. The method according to any of the preceding claims, wherein the winding angle of the tape (10) relative to the direction X is comprised between +90° and −90°.

19. The method according to claim 18, wherein the winding angle is +/−54.8° to +/−10°, preferably +/−5°, more preferably +/−1°.

20. The method according to any of the preceding claims, wherein the textile preform produced in the step i) comprises a variation of section, in particular sequential along the direction X.

21. The method according to any of the preceding claims, wherein step ii) is carried out in a mold, in particular external to the preform, more particularly a closed mold.

22. The method according to any of the preceding claims, wherein step ii) the pressure is applied by means of a bladder internal to the preform.

23. The method according to any of the preceding claims, wherein prior to step ii) an insert is positioned at the ends of the preform obtained in step i), preferably outside the ends of the preform.

24. The method according to claim 23, wherein the insert is made, if appropriate, of a composite thermoplastic material.

25. The method according to claims 23 and 24, wherein in step ii) the insert is co-consolidated with the tapes (10) during the consolidation step ii).

26. A tank, in particular for storing a fluid under pressure, more particularly hydrogen, comprising at least one textile and consolidated elongate element, which can be obtained according to the method as defined in claims 1 to 25.

27. The tank according to claim 26, wherein each consolidated elongate element is provided with an insert at the ends thereof.

28. The tank according to claim 27, wherein the insert is:
an insert closing the elongate and consolidated element, or
an insert with an orifice, intended to let the fluid in and out.

29. The tank according to claims 26 to 28, comprising a plurality of consolidated elongate elements, in series, connected to each other via connectors.

30. An unconsolidated and elongate textile preform which can be obtained according to step i) of the method according to claims 1 to 25.

31. A battery pack, in particular for a motor vehicle, comprising a hydrogen storage tank according to one of claims 26 to 29.
